(19) United States
(12) Patent Application Publication
(10) Pub. No.: US 2014/0254574 A1
(43) Pub. Date: Sep. 11, 2014

(54) FIREWALL ACCESS FOR INBOUND VOIP CALLS

(71) Applicant: BRITISH TELECOMMUNICATIONS public limited company, (US)

(72) Inventor: Marc Sidney Dirk SCHREUDER, Mountain View, CA (US)

(73) Assignee: BRITISH TELECOMMUNICATIONS PUBLIC LIMITED COMPANY, London (GB)

(21) Appl. No.: 13/785,011

(22) Filed: Mar. 5, 2013

(51) Int. Cl. H04M 7/00

(52) U.S. Cl. CPC H04M 7/0066
USPC 370/338; 370/328

(57) ABSTRACT

A method and a system for providing firewall access to inbound calls in a Voice over Internet Protocol (VoIP) communication session. The server, after receiving a message for an incoming call, sends a PUSH alert notification to the destination device via a cellular network which lacks firewalls to stimulate creation of a new pin hole through the firewall by a renewed registration from the destination device of a Session Initiation Protocol (SIP) application.

### TECHNICAL FIELD

The technology herein relates to a method and apparatus for providing firewall access to inbound calls in a Voice over Internet Protocol (VoIP) communication session. In more detail, the technology herein relates to a server, which, after receiving a message for an incoming call, pushes an alert notification to the destination device via a cellular network lacking firewalls, thereby enabling the destination device to cooperate in establishing a VoIP connection.

### BACKGROUND AND SUMMARY

The Internet has brought a lot of technological advances in the telecommunications industry. For example, Voice over Internet Protocol (VoIP) allows the transmission of voice over a data network that supports Internet Protocol (IP), e.g., an Ethernet or WiFi network, the Internet, etc. This allows users to share internet resources and communicate with each other at a lower rate (since a user pays a monthly fee for internet use, whereas traditional dial tone services require usage charges). With an expanding wireless and mobile technology, VoIP helps users communicate with remote sites by allowing voice to stream across data networks and the Internet.

The Session Initiation Protocol (SIP) is a signaling protocol used for controlling communication sessions such as voice and video calls over IP. SIP is primarily used in setting up and tearing down voice or video calls. It also allows for modification of existing calls. The modification may involve changing addresses or ports, inviting more participants, and adding or deleting media streams. SIP may also be used in messaging applications, such as instant messaging, and event subscription and notification.

A SIP user agent (UA) is a network end-point used to create or receive SIP messages and manage a SIP session. A SIP UA can either perform the role of a User Agent Client (UAC), which sends SIP requests, or the role of a User Agent Server (UAS), which receives the requests and returns a SIP response. These roles of UAC and UAS only last for the duration of a SIP transaction.

“Push” (PUSH) is a general term which refers to technologies that allow a data service provided by cellular networks to send, or push, information to an end-user, e.g., a mobile device, without action on the part of the user. For example, with PUSH email, emails are pushed directly to the mobile device as soon as the email server receives them. However, conventionally, this technology presents security problems since the user's SIP account information is included in the push.

One problem for SIP-based communication is that messages, such as an incoming VoIP call, can not automatically reach users on an IP data network, such as, for example, a local area network (LAN), or WiFi, which is protected by firewalls and Network Address Translation (NAT) routers. Firewalls are designed to prevent inbound unknown communications (the firewall must recognize the format of the signaling in order to admit it to the network) and NAT stops users on a LAN from being addressed from the outside (by hiding the private IP addresses on the LAN).

SIP servers are often placed on the IP data network. However, in order for them to communicate over the networks, SIP traffic must be able to traverse the firewall. One typical method for enabling traversal of firewalls by SIP messages is to continuously send dummy packets through the firewall to keep pin holes open for the media to cross, or by asking the client to re-register in short intervals to keep those ports available. However, this continuous transmission significantly impacts battery life of the mobile user device.

FIG. 1 illustrates a conventional SIP communication network. A user connects his/her smartphone 1 to an IP data network, such as, for example, a WiFi/LAN network 2. The smartphone is assigned an IP address in the WiFi/LAN network 2 by a router (not shown). Next, the user starts a SIP application on the smartphone 1. Typically, especially if the user wants to send an outgoing call upon starting, the SIP application sends a REGISTER message to the SIP server 5. In order for the REGISTER signal to traverse the firewall 3, the firewall 3 creates a “pin hole”, thus allowing the outgoing REGISTER signal to pass through the firewall 3. The REGISTER signal is then routed over the Internet 4 to the SIP server 5. The pin hole also allows a response from the SIP server 5 to return to the device 1. The SIP server 5 records the IP address and port number from which the REGISTER signal was originated.

After a variable amount of time, defined by the individual router and firewall settings for the WiFi/LAN network 2, the pin hole is closed. Therefore, when the SIP server 5 sends another message to the same IP address and port number, the firewall 3 will ignore it and drop the traffic.

Subsequently, when another party attempts to place a VoIP call to the SIP application of the user, this request arrives at the SIP server 5, which then sends an INVITE message to the registered IP address and port number of the user. However, because the pin hole in the firewall 3 is closed, the INVITE message does not make it to the SIP application in the smartphone 1 of the user as the firewall 3 drops the message. Thus, the user does not receive an incoming call alert and misses the SIP VoIP call.

Therefore, it would be beneficial if a method allowed messages from the SIP server to reach the destination SIP application through a firewall in an IP data network, without traversal of a firewall being prevented because the firewall lacks a pin hole, or because the firewall is being forever disabled by the closing of initial pin holes in the firewall after a certain amount of time, thus allowing effectively continuous reception of an VoIP call by the SIP application.

In one exemplary illustrative non-limiting implementation, when a SIP server receives a message destined to a remote SIP user, the SIP server, in addition to possibly sending the message to the SIP user, it sends a PUSH alert via a cellular network which lacks firewalls. The SIP application on the destination device receives the cellular PUSH notification, which in turn triggers the SIP application to transmit a new REGISTER message to the SIP server which opens or refreshes the connection through the firewall of the IP data network, and enables the SIP server to now successfully direct the VoIP call to the SIP application of the user.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 schematically shows a conventional SIP communication arrangement between a SIP user and a SIP server via an IP data network, such as, for example, a WiFi/LAN network and the Internet.

FIG. 2 schematically shows an exemplary non-limiting implementation of a SIP communication arrangement between a SIP user and a SIP server via an IP data network, such as, for example, a WiFi/LAN network and the Internet which also incorporates a PUSH notification to the SIP user via a cellular network.

FIG. 3 shows an exemplary illustrative non-limiting computer program code structure flowchart for implementing the receiving of incoming VoIP calls and the sending of outgoing VoIP calls through an IP data network, such as, for example, a WiFi/LAN network by a SIP user in the communication system of FIG. 2.

FIG. 4 shows an exemplary illustrative non-limiting computer program code structure flowchart for implementing the receiving of incoming VoIP calls through an IP data network, such as, for example, a WiFi/LAN network by a SIP user in the communication system of FIG. 2.

FIG. 5 shows an exemplary illustrative non-limiting computer program code structure flowchart for implementing the sending of outgoing VoIP calls through an IP data network, such as, for example, a WiFi/LAN network by a SIP user in the communication system of FIG. 2.

FIG. 6 shows another exemplary illustrative non-limiting computer program code structure flowchart for implementing the sending of incoming VoIP calls to a SIP user by a SIP server in the communication system of FIG. 2.

### DETAILED DESCRIPTION

Techniques described herein can be performed using any type of a mobile device including, a portable personal computer, a mobile phone, or any other type of device or arrangement having SIP VoIP capabilities. Moreover, the transmission technologies that IP can traverse, in addition to WiFi and LAN, include, for example, GPRS, 3G, 4G, LTE and other data technologies, such as WiMax, satellite data connections, etc. One exemplary illustrative non-limiting implementation is described below, but other implementations are possible.

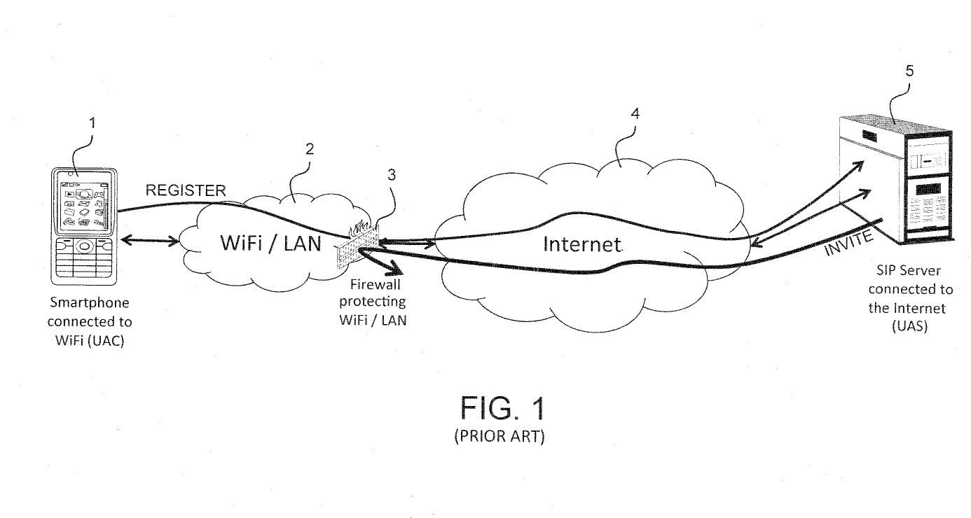

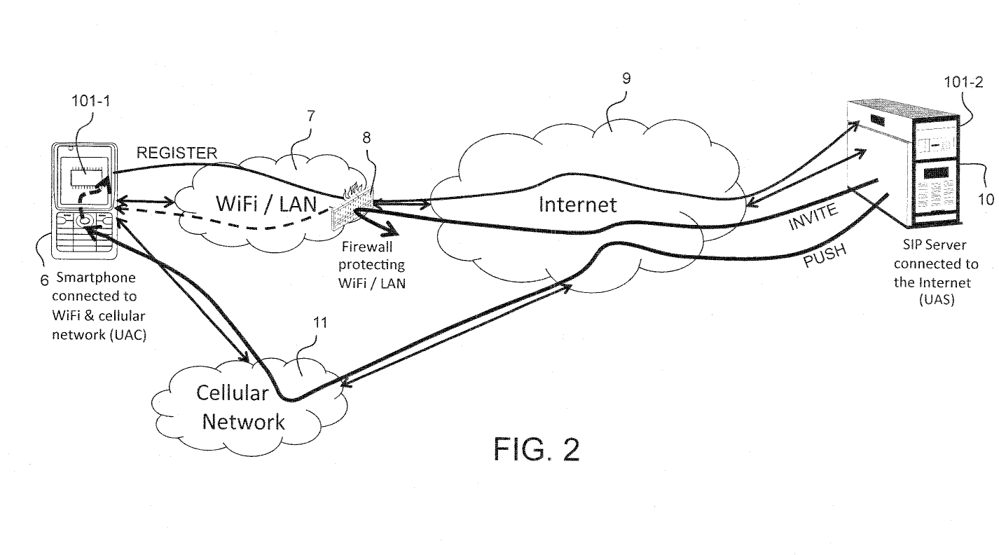

FIG. 2 illustrates a SIP VoIP communication network according to a non-limiting exemplary embodiment of the technology presented herein. As in the configuration of FIG. 1, a user connects his/her smartphone 6 to an IP data network, e.g., WiFi/LAN network 7, and typically registers to the SIP server 10, especially if the user wants to send an outgoing call, by sending a REGISTER message to the SIP server 10 via the Internet 9. As discussed above, the firewall 8 of the WiFi network 7 briefly opens a “pin hole”, which closes after a variable time period.

Subsequently, another party attempts to place a SIP VoIP call to the SIP application on smartphone 6. The SIP server 10 will then send a PUSH notification to the SIP application.

The PUSH notification is delivered to the smartphone 6 via a cellular network 11 which lacks a firewall. Upon receiving the PUSH notification, the SIP application of the smartphone 6 immediately initiates a new REGISTER process by sending a new REGISTER message to possibly update the SIP server 10 with a currently assigned SIP application IP address and port number, thus causing the firewall 8 to again briefly open a new “pin hole”.

The SIP server 10 continues to send INVITE messages to the SIP application, but now these messages pass through the new firewall “pin hole” and the SIP application receives them, thus enabling the call to connect (the pin hole being kept open by continued VoIP activity for the duration of the call).

In another exemplary illustrative non-limiting implementation, the SIP server, upon receiving an incoming SIP VoIP call for the destination device, may or may not simultaneously send an INVITE message to the SIP application utilizing the IP address and port number previously recorded from a received REGISTER message from the user of the smartphone 6 along with a PUSH notification via the cellular network. Possibly, only the PUSH notification is sent and the SIP server waits to send an INVITE message to the SIP application until it receives a REGISTER message (stimulated by receipt of the PUSH message).

Thus, the technology presented herein utilizes cellular PUSH in addition to SIP functionality to reliably send an initial incoming call alert. The functionality of the SIP server is extended, such that when the SIP server receives an INVITE message, it sends a PUSH alert via a cellular network lacking firewalls. In this way, the transmission of INVITE messages to the SIP application on the smartphone immediately follows the new opening of a “pin hole” in the IP data network (caused by the SIP application which has been PUSH-notified about an incoming call), thus overcoming the inability of SIP signals to traverse firewalls in IP data networks lacking a “pin hole”, or after an earlier created “pin hole” has closed.

An alternative to the above disclosed way to overcome the closing of the “pin holes” in the firewall of the IP data network after a time period, thus causing the drop of incoming VoIP calls, would be to have the SIP application on the smartphone periodically re-REGISTER with the SIP server. If done often enough, this could keep the firewall “pin hole” open. However, this method suffers from at least the following disadvantages.

First, the continuous sending of REGISTER messages requires the application to consume a great amount of battery power. In turn, this will drain the smartphone's battery much faster, and could lead the user to disable the application, as the smartphone's Operating System will identify the SIP application as a big battery consumer.

Second, the continuous REGISTERing puts an unnecessary load onto the SIP server, as it has to process multiple REGISTER messages, as well as consuming operational capacity in the form of sessions.

Conventional methods which require the SIP application to remain active (in order to continuously keep “pin holes” open) consume battery power, with the major disadvantage being the reduced operating time before charging. In contrast, with the method disclosed herein, users with SIP applications on their phones receive incoming VoIP calls without dropped calls or increased battery consumption.

Moreover, conventional PUSH notifications (to notify a user of external events) present security problems since the user's username/password is sent over the Internet every single time the phone starts up. In contrast, with the method disclosed herein, the SIP application preferentially maintains a cached copy of the user's SIP credentials, and a PUSH is used merely to notify the SIP application that there is an inbound call, and then the application uses the earlier cached credentials to register and receive the call.

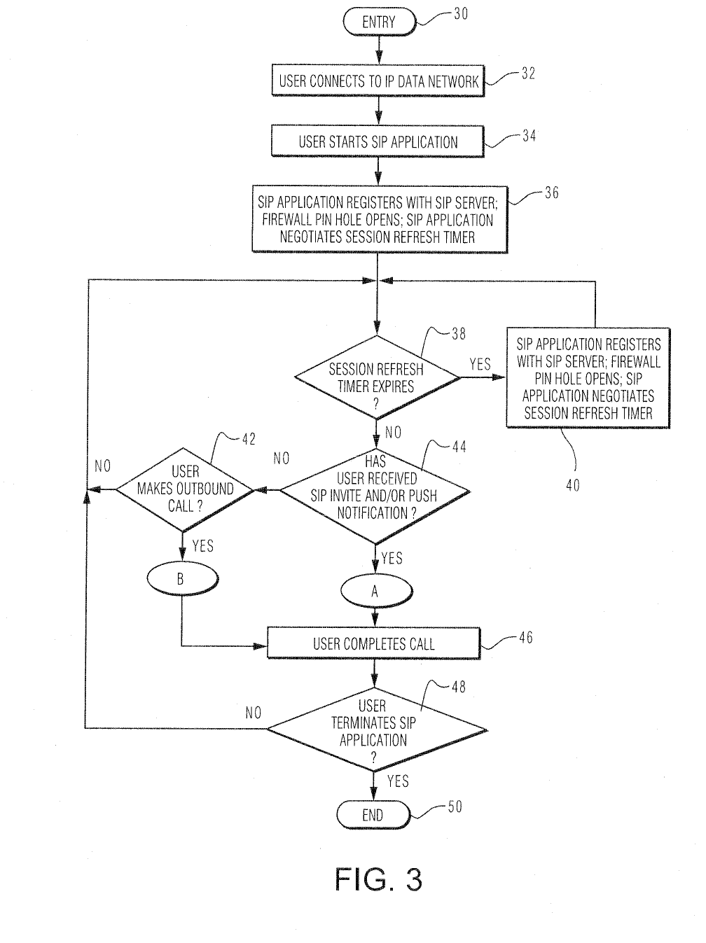

FIG. 3 is a flowchart of an exemplary illustrative non-limiting computer program code structure which, when executed by CPU 101-1 of smartphone 6, effects a process for the smartphone 6 receiving incoming VoIP calls, or making outbound VoIP calls, through an IP data network, such as, for example, an WiFi/LAN network 7. After entry at 30, in step 32, the user connects his/her smartphone 6 to an IP data network 7. Next, in step 34, the user starts a SIP application on the smartphone. The SIP application then typically registers with SIP server 10 in step 36 (this will open a temporary pin hole in the firewall 8) and the SIP application sets a session refresh timer (if the timer is set too low, then this results in the very problem this technology addresses, i.e., increased battery drain).

However, the SIP application does not have to start with a registration with the SIP server. This may happen, for example, in two situations. First, the SIP application may be specifically configured so that it does not immediately register with the SIP server. Or, the SIP application will not start with a registration if it has not been provided with configuration data, such as SIP username, SIP password and SIP server address.

If the user has started the SIP application and has registered but does nothing after that, then the process goes to step 38, where it is determined if the session refresh timer has expired. If the answer is affirmative, then the SIP application will perform a new registration with the SIP server, thus opening a new temporary firewall pin hole in step 40, and the process goes back to step 38. It is noted that the user is not aware of the refresh taking place, as it happens in the background. Also, the refresh may actually be initiated by the SIP server. The SIP application may initiate the refresh or the SIP server may initiate the refresh depending on parameters set in the initial registration protocol.

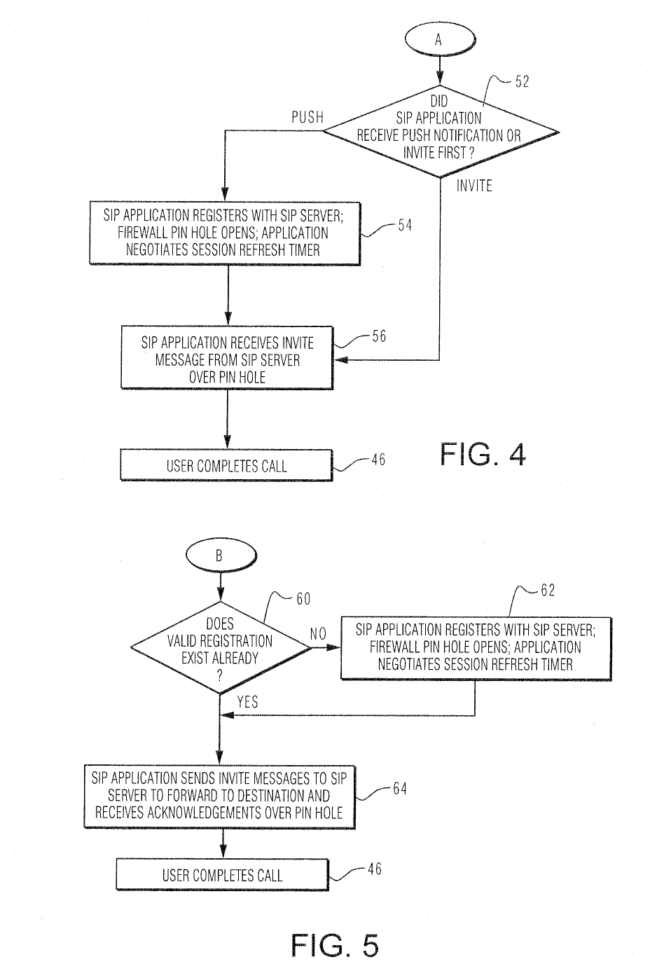

If the answer in step 38 is negative, then the process goes to step 44 where it is determined if the user is receiving an inbound call either by the SIP application receiving a SIP INVITE and/or by receiving a PUSH notification. If no inbound call is being received, then the process goes to step 42. On the other hand, if an inbound call is being received then the process goes to sub-routine A shown in FIG. 4, discussed later. At step 42, it is determined whether the user is making an outbound call. If not, then the process goes back to step 38. However, if the user is making an outbound call, then the process goes to sub-routine B shown in FIG. 5, discussed later.

After the SIP application has finished receiving an inbound call, or it has finished sending an outbound call, thus the user has completed the call at step 46, then the process goes to step 48 where it is determined whether the user has terminated the SIP application. If yes, then the process is exited at step 50 (e.g., to other VoIP processes). If the user has not terminated the SIP application, then the process goes back to step 38.

After the possible initial registration, any of three events may occur. More specifically, the SIP application may receive an inbound call (INVITE message) and/or a PUSH notification, the user may make an outbound call, or the session refresh timer may expire. When each one of these events occurs, it may trigger a new registration with the SIP server although, most commonly, a new registration is triggered on receipt of a PUSH notification (the technology presented herein) or the session refresh timer expiring. Even though in the embodiment discussed above, the SIP application first checks whether there has been an inbound call and then checks whether the user is making an outbound call, in another exemplary, non-limiting implementation, this order may be switched. The application continues to run in the background on the smartphone, waiting for an event to occur (user makes a call, someone calls the user or the session timer expires) and then taking action when that event occurred.

If the SIP application does not register with the SIP server upon start-up, then the SIP application would wait for a PUSH notification and/or wait for the user to attempt to make an outbound call. Moreover, even after the user completes the call, in step 46 in FIG. 3, the SIP application may de-register from the SIP server and then return to the loop waiting for one of two options-a PUSH to arrive or the user to make an outbound call-to occur.

FIG. 4 is a flowchart of an exemplary illustrative non-limiting computer program code structure which, when executed by CPU 101-1 of smartphone 6, effects a process for smartphone 6 receiving incoming VoIP calls through an IP data network. When an inbound call arrives, i.e., the answer to the query in step 44 in FIG. 3 is affirmative, then the process goes to step 52 where it is determined whether a PUSH notification or an INVITE was received first. If the answer is that the INVITE arrived first, that means the firewall pin hole is still open, or the firewall settings have been specifically configured so there is no temporary pin hole, and the SIP application will receive the INVITE messages from the SIP server over the pin hole in step 56. If instead, the SIP application received a PUSH notification first, that triggers the SIP application to register with the SIP server in step 54, which opens the firewall pin hole. This is in contrast to conventional SIP communications, where the person making the SIP call would get a response to indicate that the destination is not available.

In step 54, upon receiving the PUSH notification, the SIP application initiates a new registration with SIP server 10 possibly updating the SIP server with the SIP application's IP address and port number currently assigned to smartphone 6 (thus opening a new firewall pin hole), and also negotiating the session refresh timer. After the transmission of the new REGISTER message in step 54, the SIP application receives INVITE messages from the SIP server, establishing a VoIP call, in step 56. Then the user ends the call, in step 46.

FIG. 5 is a flowchart of an exemplary illustrative non-limiting computer program code structure which, when executed by CPU 101-1 of smartphone 6, effects a process for the smartphone 6 making outbound VoIP calls through an IP data network. If a user decides to make an outbound call, i.e., the answer to the query in step 42 in FIG. 3 is affirmative, the SIP application will determine if a valid registration with the SIP server exists already, in step 60. If the answer is negative, then the SIP application will perform a new registration with the SIP server, thus opening a new firewall pin hole, in step 62, before continuing to place the call by sending INVITE messages to the SIP server at step 64 and completing the call at step 46. If the answer is affirmative, then the SIP application will not have to register again. The SIP application will send invite messages to the SIP server to forward to the destination and receive acknowledgement over the newly opened pin hole and the outbound call is made in step 64 and the user completes the call in step 46.

In SIP communication, INVITE messages are exchanged whether a party receives or makes a call. The side initiating the call is the side that sends the INVITE, see step 64. The receiving side gets the INVITE and responds with an acknowledgment, see step 56. The sending side must receive this acknowledgment in order for the call to be set up.

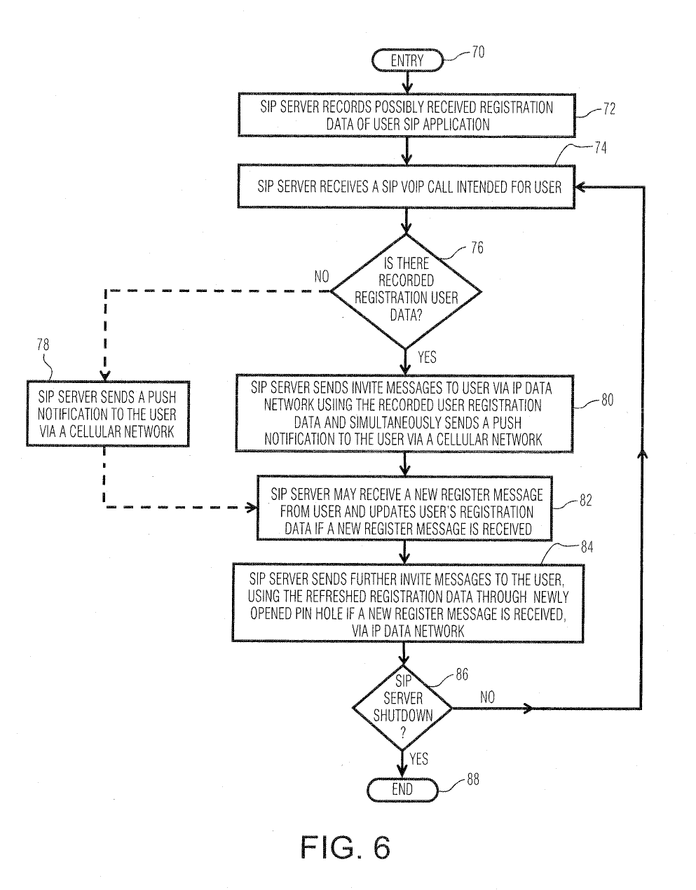

FIG. 6 is a flowchart of an exemplary illustrative non-limiting computer program code structure which, when executed by CPU 101-2 of SIP server 10, effects transmitting of VoIP calls to the SIP application of smartphone 6. After entry at 70, SIP server records possibly received registration data of a user's smartphone's SIP application in step 72, if such registration data is transmitted by the SIP application. Next, in step 74, the SIP server 10 may receive a SIP VoIP call intended for the SIP application of the user. Subsequently, the process goes to step 76, where it is determined whether there is recorded registration user data in the SIP server. If the answer is positive, the SIP server sends INVITE messages to the user via the Internet and the IP data network, such as, for example, the WiFi/LAN network, using the recorded registration user data and simultaneously sends a PUSH notification to the user via cellular network 11 at step 80 and proceeds to step 82. If the answer is negative (i.e., if there is no recorded registration user data), the SIP server just sends a PUSH notification to the user via cellular network 11, at step 78 and proceeds to step 82. In step 82, the SIP server receives a possibly new updated REGISTER message from the user and updates its user's registration data. If the SIP server received an updated REGISTER message, the SIP server's subsequent INVITE messages are sent to the user through the newly opened pin hole, and establishment of the VoIP call is completed, at step 84, and the process then goes to decision step 86.

The SIP server continues to process calls until it either crashes or a hardware failure occurs (abnormal operations) or alternatively, until the physical server is restarted/shut down or the process itself is shut down by an operator (normal operations). The server is in a continuous loop, i.e., going from step 86 back to step 74, if the answer at the decision step 86 is negative. If the answer at step 86 is affirmative, then the process exits at 88.

While the technology herein has been described in connection with exemplary illustrative nonlimiting implementations, those skilled in the art will recognize many corresponding and equivalent arrangements which are all intended to be covered by the appended claims.

What is claimed is:

1. A computer-implemented method for establishing reception by a destination device of an incoming Voice over Internet Protocol (VoIP) call, the method comprising:
configuring at least one central processing unit (CPU) of the destination device to:
connect the destination device to an Internet Protocol (IP) data network;
receive a PUSH notification message from a Session Initiation Protocol (SIP) server, via a cellular network, after the SIP server receives an incoming VoIP call;
initiate registration of a SIP application installed on the destination device with the SIP server connected to the IP data network via the Internet, by transmitting a REGISTER message to the SIP server via the IP data network and the internet, wherein the REGISTER message causes a firewall in the IP data network to open a traversal pin hole; and
receive the VoIP call from the SIP server via the newly opened pin hole to the IP data network and the Internet.

2. The computer-implemented method according to claim 1, wherein:
said at least one CPU of the destination device is further configured to:
upon starting the SIP application, initiate registration of the SIP application with the SIP server connected to the IP data network via the internet, by transmitting a REGISTER message to the SIP server via the IP data network and the internet.

3. The computer-implemented method according to claim 1, wherein
the destination device is a mobile device.

4. The computer-implemented method according to claim 1, wherein
the IP data network is a WiFi or LAN network.

5. A computer-implemented method for establishing successful transmission by a Session Initiation Protocol (SIP) server to a destination device of an incoming Voice over Internet Protocol (VoIP) call, the method comprising:
configuring at least one central processing unit (CPU) of the SIP server to:
receive an incoming SIP VoIP call intended for a destination device;
send a PUSH notification to the destination device via a cellular network;
receive a REGISTER message from the destination device through an Internet Protocol (IP) data network and the internet, after the destination device receives the PUSH notification, and update registration data for the SIP application of the destination device in response to the REGISTER message; and
send an INVITE message to the destination device via the internet and a pin hole through the IP data network newly opened by processing of the REGISTER message.

6. The computer-implemented method according to claim 5, wherein:
said CPU of the SIP server is further configured to:
upon receiving an incoming SIP VoIP call intended for a destination device, send INVITE messages to the destination device via the internet and the IP data network simultaneously with sending a PUSH notification to the destination device via the cellular network.

7. The computer-implemented method according to claim 5, wherein
the destination device is a mobile device.

8. The computer-implemented method according to claim 5, wherein
the IP data network is a WiFi or LAN network.

9. A communication system comprising a Session Initiation Protocol (SIP) server and a destination device, for establishing successful reception by the destination device of an incoming Voice over Internet Protocol (VoIP) call, the system including one or more computer processors configured to:
connect the destination device to an Internet Protocol (IP) network;
receive an incoming SIP VoIP call intended for the destination device at the SIP server;
send a PUSH notification to the destination device via a cellular network;
initiate registration of the SIP application on the destination device with the SIP server in response to the destination device receiving the PUSH notification, by transmitting a REGISTER message to the SIP server via the IP data network and the internet; and
send an INVITE message from the SIP server to the destination device via the internet and a pin hole through the IP data network newly opened by processing of the REGISTER message.

10. The communication system according to claim 9, wherein
the one or more computer processors is further configured to:
upon starting a SIP application, register the SIP application with the SIP server connected to the IP data network via the internet, by transmitting a REGISTER message from the SIP application to the SIP server via the IP data network and the internet, wherein the REGISTER message causes a firewall in the IP data network to open a temporary traversal pin hole;
upon receiving an incoming SIP VoIP call intended for the destination device send INVITE messages from the SIP server to the destination device via the internet and the IP data network based on recorded registration data, and simultaneously send a PUSH notification to the destination device via the cellular network which causes the destination device to send a new REGISTER message to the SIP server.

11. The communication system according to claim 9, wherein
the destination device is a mobile device.

12. The communication system according to claim 9, wherein
the IP data network is a WiFi or LAN network.
